(19) United States
(12) Patent Application Publication
(10) Pub. No.: US 2020/0369309 A1
(43) Pub. Date: Nov. 26, 2020

(54) Board and Boat Caddy

(71) Applicant: Steven Nothern, Palm Beach Shores, FL (US)

(72) Inventor: Steven Nothern, Palm Beach Shores, FL (US)

(21) Appl. No.: 16/420,572

(22) Filed: May 23, 2019

(51) Int. Cl. B62B 3/10; B62B 3/02; B62B 3/04

(52) U.S. Cl. CPC B62B 3/108; B62B 2202/90; B62B 3/04; B62B 3/025

(57) ABSTRACT

A caddy that has a frame, the frame comprising four wheels, each wheel coupled to a corner of the frame. The caddy also has a first cradle coupled to a first end of the frame and a second cradle coupled to a second side of the frame wherein the first cradle receives a first end of a water apparatus and the second cradle receives a second end of the water apparatus for transporting the water apparatus.

### BACKGROUND OF THE DISCLOSURE

Stand up paddle boarding has become hugely popular in recent years. A stand-up paddle board typically is oval-shaped with a flat bottom. In use, one stands on a top flat surface of the paddle board and using a paddle, glides through the water. There are different types of paddle boards depending upon their use. There are certain paddle boards for ocean paddling, lake paddling, etc.

Often one travels to his/her water destination, e.g., an ocean or a lake. In order to begin paddling on the ocean or lake, he/she must carry the paddle and the stand-up paddle board to the water. This can prove to be onerous. This is especially true in regard to ocean paddling because he/she must carry the paddle and the stand-up paddle board through a sandy beach to reach the ocean waters.

Also, it is popular for individuals to use kayaks and canoes. Typically, one must carry his/her kayak or canoe to the water prior to travelling on the water in the kayak or canoe. Carrying the kayak or canoe to the water can prove to be onerous.

### BRIEF DESCRIPTION OF THE DRAWINGS

The water implement is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of an exemplary caddy in accordance with an embodiment of the present disclosure.

FIG. 2 is a side view of caddy shown in FIG. 1 carrying a paddle board.

FIG. 3 is a perspective view of the caddy shown in FIG. 1 partially folded for storage.

FIG. 4 is a perspective view of the caddy shown in FIG. 1 fully folded for storage.

FIG. 5 is a perspective view of an exemplary caddy in accordance with an embodiment of the present disclosure for carrying a kayak.

FIG. 6 is a side view of caddy shown in FIG. 5 carrying a kayak.

FIG. 7 is a perspective view of an exemplary caddy in accordance with an embodiment of the present disclosure for carrying a canoe.

FIG. 8 is a side view of caddy shown in FIG. 7 carrying a canoe

### DETAILED DESCRIPTION

The detailed description describes an exemplary caddy in accordance with an embodiment of the present disclosure for carrying water apparatuses to the edge of the water to embark on a ride on the water apparatus. Exemplary apparatuses include, but are not limited to, paddle boards, surfboards, kayaks, and canoes.

The exemplary caddy comprises a substantially rectangular frame, and at each corner of the frame is a wheel. Thus, the caddy has at least four wheels. However, other numbers of wheels are possible in other embodiments. Also, the frame may be other shapes in other embodiments. For example, the frame may be oval or square.

Rotatably coupled to a cross bar on an end of the frame is a cradle. In one embodiment, the cradle comprises a central U-shaped bar that is integral on either side with inverted U-shaped bars. The cradle may rotate flush with the frame to an upright position slightly bending at an angle outwardly away from the center of the frame. Further, rotatably coupled to a cross bar on the other end of the substantially rectangular frame is another cradle. The cradle comprises a central U-shaped bar that is integral on either side with inverted U-shaped bars. The cradle may rotate flush with the frame to an upright position slightly bending at an angle outwardly away from the center of the frame. In such an embodiment, the caddy is configured to carry a paddle board. Note that the central bars may be other shapes in other embodiments. Further, the inverted U-shaped bars may be other shapes in other embodiments.

In another embodiment, coupled to one end of the frame is a cradle. The cradle comprises a central bar that is integral on either side with inverted U-shaped bars. The central bar comprises two side bars that are connected at a bottom end of the side bars by another straight bar. The cradle may rotate flush with the frame to an upright position slightly bending at an angle outwardly away from the center of the frame. Further, rotatably coupled to a cross bar on the other end of the is another cradle. The cradle comprises a central bar that is integral on either side with inverted U-shaped bars. The central bar comprises two side bars that are connected at a bottom end of the side bars by a straight bar. The cradle may rotate flush with the frame to an upright position slightly bending at an angle outwardly away from the center of the frame. In such an embodiment, the caddy is configured to carry a kayak.

In another embodiment, coupled to one end of the frame is a cradle. The cradle comprises a substantially rectangular-shaped bar. The cradle may rotate flush with the frame to an upright position slightly bending at an angle outwardly away from the center of the frame. Further, rotatably coupled to a cross bar on the other end of the substantially rectangular frame is another cradle. The cradle comprises a substantially rectangular-shaped bar. The cradle may rotate flush with the frame to an upright position slightly bending at an angle outwardly away from the center of the frame. In such an embodiment, the caddy is configured to carry a canoe.

The caddy can be used to transport paddle boards, surf boards, kayaks, canoes or the like. In this regard, a paddle board, surfboard, kayak, canoe, or the like may be placed on the cradles of the caddies described.

In one embodiment, the frame is hingedly coupled on opposing sides of the frame at joints. Thus, when a user desires to store the caddy, the user may rotate the cradles so that they are flush with the frame. The user may then bend the frame at the joints so that a portion of the frame rotates around so that it is adjacent the other portion of the frame. The caddy is then in a compact shape to be stored for future use.

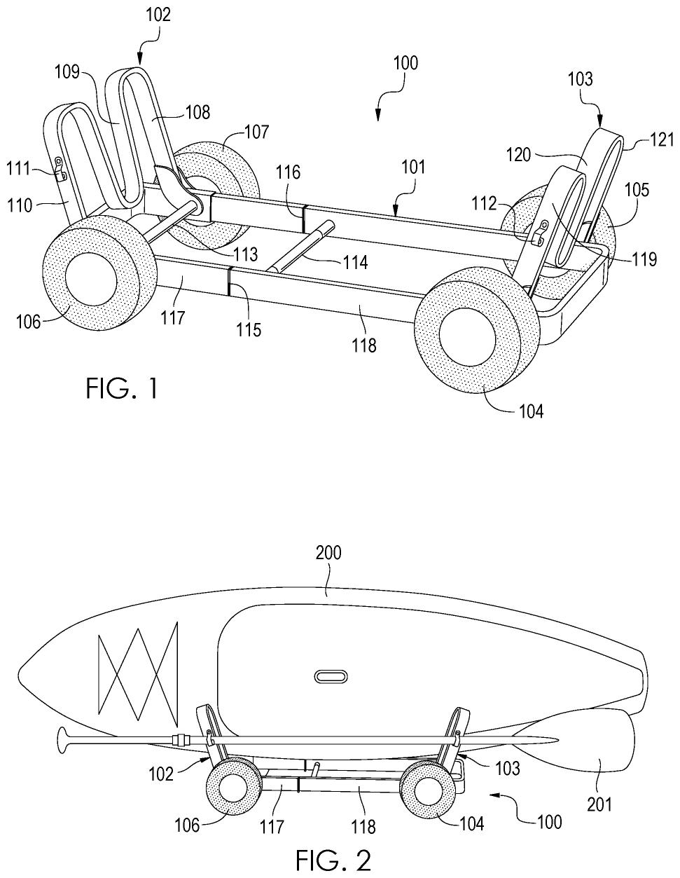

FIG. 1 is a perspective view of an exemplary caddy 100 in accordance with an embodiment of the present disclosure for carrying paddle boards. In one embodiment, the caddy 100 comprises a substantially rectangular frame 101. The substantially rectangular frame 101 comprises at least one cross bar 114 to support the frame 101. Note that the frame 101 may be other shapes in other embodiments. For example, the frame 101 may be oval or square.

The frame 101 comprises two portions, including portion 117 and portion 118. On a side of the substantially rectangular frame 101, the frame portion 117 is hingedly coupled at joint 115 to frame portion 118, and on the other side of the substantially rectangular frame 101, the frame portion 117 is hingedly coupled at joint 116 to frame portion 118. This is described further with reference to FIG. 4.

Coupled at each corner of the substantially rectangular frame 101 are wheels 104-107. In use, the wheels 104-107 allow the caddy 100 to be easily moved, which is described further with reference to FIG. 2. In this regard, the wheels 104-107 of the caddy 100 are configured to aid in movement of the caddy 100 especially over rough, uneven or sandy terrain. That is, the wheels 104-107 are configured such that they are suitable for traversing over a sandy beach or an uneven terrain.

The caddy 100 comprises two cradles 102 and 103. The cradle 102 is rotatably coupled to the frame 101 via a cross bar 113. Further, the cradle 103 is rotatably coupled to the frame 101 via a cross bar (not shown). FIG. 1 shows the cradles 102 and 103 in an upright position. The cradle 102 and 103 can be slightly angled outwardly from the center of the frame 101.

In one embodiment, the cradle 102 comprises a central U-shaped bar 109. The central U-shaped bar 109 is integral on each side with inverted U-shaped bars 110 and 108. Note that the central bar may be other shapes in other embodiments. For example, the central bar could be V-shaped. Further, the cradle 103 comprises a central U-shaped bar 120. The central U-shaped bar 120 is integral on each side with inverted U-shaped bars 119 and 121. Note that the central bar may be other shapes in other embodiments. For example, the central bar could be V-shaped. The central U-shaped bars 109 and 120 are configured for receiving and securing a board therein. The inverted U-shaped bars 110, 108, 119, and 121 serve as support to ensure that the board does not fall from the caddy 100. Note that the inverted U-shaped bars 110, 108, 119, and 121 may be other shapes in other embodiments.

Additionally, the cradles 102 and 103 may comprise clips 111 and 112, respectively and the cradles 102 and 103 may comprise two additional clips (not shown) on the back side of the cradles 102 and 103. The additional clips are positioned similarly to clips 111 and 112 on the side exposed in FIG. 1. The clips 111, 112 and the two clips not shown are configured for retaining a paddle 201. In this regard, the paddle 201 is secured by clip 111 on one end of the caddy 100 and secured by clip 112 on the other end of the caddy 100. Also, another paddle (not shown) may be secured by a clip (not shown) on the other side of the caddy 100 on one end of the caddy 100 and secured by another clip (not shown) on the other end of the caddy 100. Further, a bungee cord could attach to clip 111, stretch over the board, and attach to the corresponding clip on the back side of the cradle 102. Further, a bungee cord could attach to clip 112, stretch over the board, and be attached to the corresponding clip on the back side of the cradle 103.

FIG. 2 is a side view of the caddy 100 hauling a board 200. Note that the board 200 may be a paddle board, a surfboard, or the like. In this regard, the board 200 rests in the U-shaped bars 109 (FIGS. 1) and 120 (FIG. 1) of the cradles 102 and 103, respectively.

The caddy 100 can then be transported. In this regard, the caddy 100 comprises the wheels 104, 105 (FIG. I), 106, and 107 (FIG. 1) to easily pull the caddy 100 over different types of terrain.

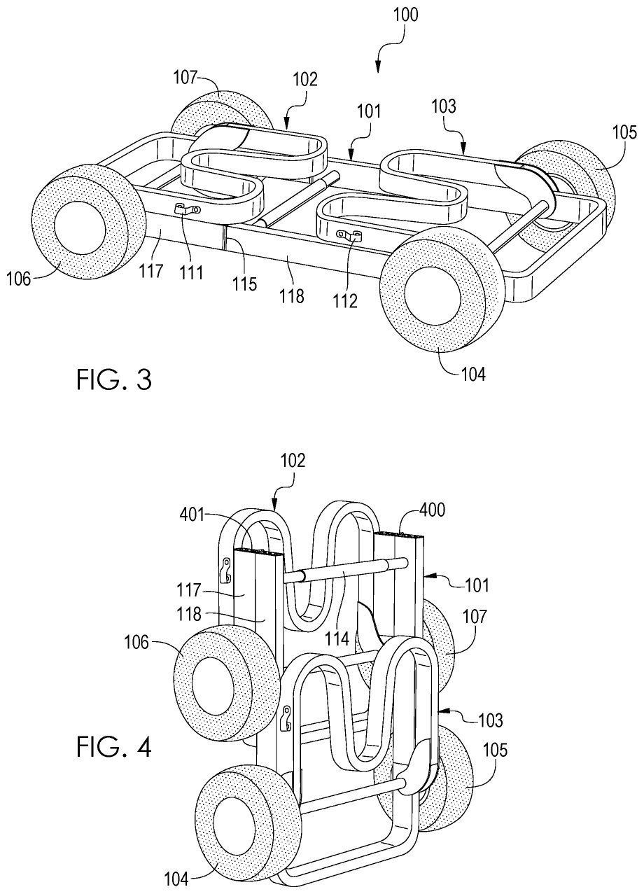

When the caddy 100 is not in use, it may be desirable to easily store the caddy. FIG. 3 is a perspective view of the caddy 100 showing the cradles rotated and resting on the frame 101 for easy storage.

In this regard, cradle 102 is rotated inwardly toward the frame portion 117 until the cradle 102 rests adjacent the frame portion 117. Additionally, cradle 103 is rotated inwardly toward the frame portion 118 until the cradle 103 rests adjacent the frame portion 118.

FIG. 4 is a perspective view of the caddy 100 in a completely collapsed position. As described with reference to FIG. 3, the cradles 102 and 103 are folded to rest adjacent the frame portions 117 and 118.

As described hereinabove, the frame portion 117 is hingedly coupled to the frame portion 118 via a hinge 401 on one side of the substantially rectangular frame 101. Further, the frame portion 117 is hingedly coupled to the frame portion 118 via a hinge 400 on the other side of the substantially rectangular frame 101. To collapse the caddy 100, the frame portion 117 is rotated around to the underside of the frame 101 via the hinges 400 and 401. The caddy 100 is then in its fully collapsed position.

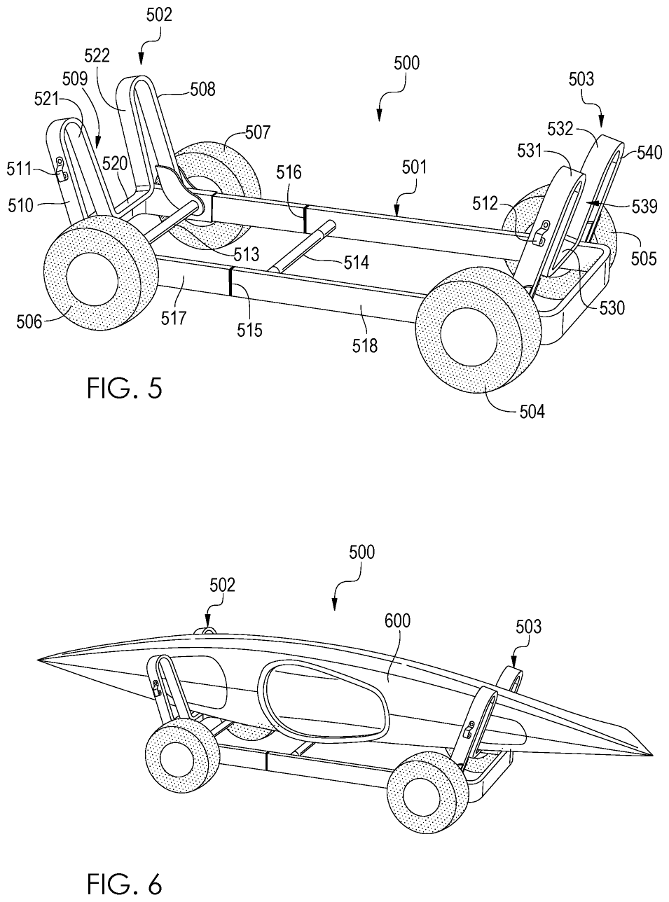

FIG. 5 is a perspective view of another caddy 500 in accordance with an embodiment of the present disclosure for carrying kayaks. The caddy 500 comprises a substantially rectangular frame 501. The substantially rectangular frame 501 comprises at least one cross bar 514 to support the frame 501. Note that the frame 501 may be other shapes in other embodiments. For example, the frame 501 may be oval or square.

The frame 501 comprises two portions, including portion 517 and portion 518. On a side of the substantially rectangular frame 501, the frame portion 517 is hingedly coupled at joint 515 to frame portion 518, and on the other side of the substantially rectangular frame 501, the frame portion 517 is hingedly coupled at joint 516 to frame portion 518. This was described herein with reference to FIG. 4.

Coupled at each corner of the substantially rectangular frame 501 are wheels 504-507. In use, the wheels 504-507 allow the caddy 500 to be easily moved, which is described further with reference to FIG. 6.

The caddy 500 comprises two cradles 502 and 503. The cradle 502 is rotatably coupled to the frame 501 via a cross bar 513. Further, the cradle 503 is rotatably coupled to the frame 501 via a cross bar (not shown). FIG. 5 shows the cradles 502 and 503 in an upright position. The cradle 502 and 503 can be slightly angled outwardly from the center of the frame 101.

The cradle 502 comprises a central bar 509. The central bar 509 comprises two side bars 521 and 522. Further, the side bars 521 and 522 are integrally connected via a horizontal bar 520 on bottom ends of the side bars 521 and 522. Note that the horizontal bar 520 is substantially perpendicular to the side bars 521 and 522. The central bar 509 is integral on each side with inverted U-shaped bars 510 and 508. The side bars 521 and 522 together with the horizontal bar 520 connecting them serve as support to ensure that the kayak does not fall from the caddy 500.

The cradle 503 comprises a central bar 539. The central bar 539 comprises two side bars 531 and 532. Further, the side bars 531 and 532 are integrally connected via a horizontal bar 530 on bottom ends of the side bars 531 and 532. Note that the horizontal bar 530 is substantially perpendicular to the side bars 531 and 532. The central bar 539 is integral on each side with inverted U-shaped bars 512 and 5540. The side bars 531 and 532 together with the horizontal bar 530 connecting them serve as support to ensure that the kayak does not fall from the caddy 500.

Additionally, the cradles 502 and 503 may comprise clips 511 and 512, respectively and the cradles 502 and 503 may comprise two additional clips (not shown) on the back side of the cradles 502 and 503. The additional clips are positioned similarly to clips 511 and 512 on the side exposed in FIG. 5. The clips 511, 512 and the two clips not shown are configured for securing a paddle (not shown). In this regard, the paddle is secured by clip 511 on one end of the caddy 500 and secured by clip 512 on the other end of the caddy 500. Also, another paddle on the other side of the caddy is secured by a clip (not shown) on one end of the caddy 500 and secured by another clip (not shown) on the other end of the caddy 500. Further, a bungee cord could attach to clip 511, stretch over the board, and attach to the corresponding clip on the back side of the cradle 502. Further, a bungee cord could attach to clip 112, stretch over the board, and attach to the corresponding clip on the back side of the cradle 503.

FIG. 6 shows the caddy 500 carrying a kayak 600. The kayak 600 is received and retained by the cradles 502 and 503. The cradles 502 and 503 ensure that the kayak does not fall off the caddy 500.

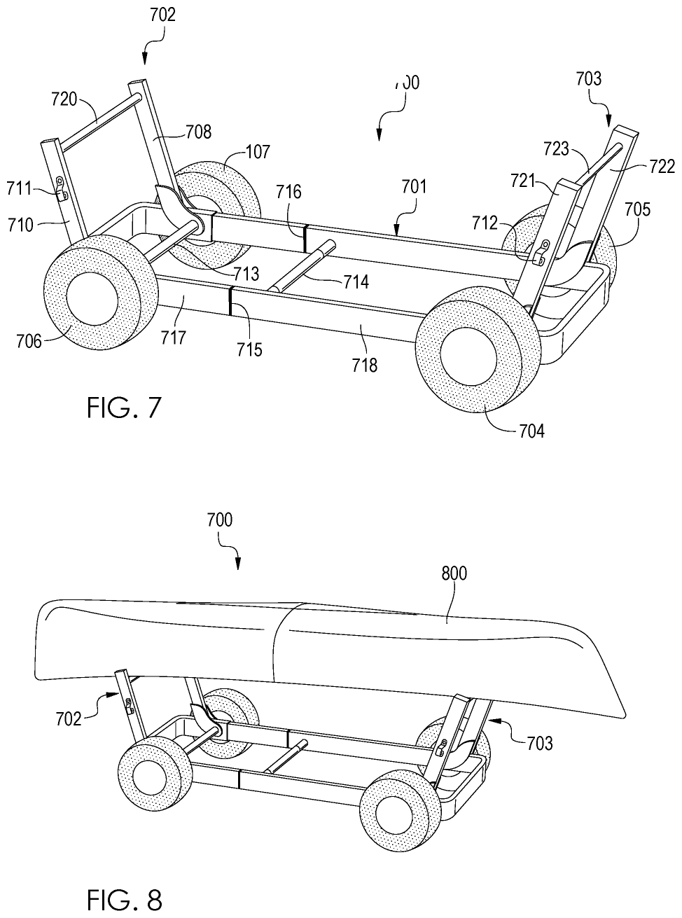

FIG. 7 is a perspective view of another caddy 700 in accordance with an embodiment of the present disclosure for carrying canoes. The caddy 700 comprises a substantially rectangular frame 701. The substantially rectangular frame 701 comprises at least one cross bar 714 to support the frame 701. The substantially rectangular frame 701 comprises at least one cross bar 714 to support the frame 701. Note that the frame 501 may be other shapes in other embodiments. For example, the frame 701 may be oval or square.

The frame 701 comprises two portions, including portion 717 and portion 718. On a side of the substantially rectangular frame 701, the frame portion 717 is hingedly coupled at joint 715 to frame portion 718, and on the other side of the substantially rectangular frame 701, the frame portion 717 is hingedly coupled at joint 716 to frame portion 718. This was described herein with reference to FIG. 4.

Coupled at each corner of the substantially rectangular frame 701 are wheels 704-707. In use, the wheels 704-707 allow the caddy 700 to be easily moved, which is described further with reference to FIG. 8.

The caddy 700 comprises two cradles 702 and 703. The cradle 702 is rotatably coupled to the frame 701 via a cross bar 713. Further, the cradle 703 is rotatably coupled to the frame 701 via a cross bar (not shown). FIG. 7 shows the cradles 702 and 703 in an upright position. The cradle 702 and 703 can be slightly angled outwardly from the center of the frame 701.

The cradle 702 is substantially rectangular. In this regard, the cradle 702 comprises the horizontal cross bar 713. The horizontal cross bar 713 is coupled on one end to vertical bars 708 and on the other end to vertical bar 710. At an opposing end of the vertical bars 708 and 710 is a horizontal bar 720 connecting the vertical bars 708 and 710. The horizontal bars 713 and 720 and the vertical side bars 708 and 710 form a rectangle-shaped cradle. In one embodiment, the vertical bars 708 and 710 extend some distance beyond the horizontal bar 720, which forms a shelf for receiving a canoe, which is shown further herein.

The cradle 703 is substantially rectangular. In this regard, the cradle 703 comprises the horizontal cross bar (not shown). The horizontal cross bar is coupled on one end to vertical bars 722 and on the other end to vertical bar 721. At an opposing end of the vertical bars 722 and 721 is a horizontal bar 723 connecting the vertical bars 721 and 711. The horizontal bar (not shown), the horizontal bar 723, and the vertical side bars 708 and 710 form a rectangle-shaped cradle. In one embodiment, the vertical bars 722 and 721 extend some distance beyond the horizontal bar 723, which forms a shelf for receiving a canoe, which is shown further herein.

Additionally, the cradles 702 and 703 may comprise clips 711 and 712, respectively and the cradles 702 and 703 may comprise two additional clips (not shown) on the back side of the cradles 702 and 703. The additional clips are positioned similarly to clips 711 and 712 on the side exposed in FIG. 7. The clips 711, 712 and the two clips not shown are configured for clipping to a paddle (not shown). In this regard, the paddle is secured by clip 711 on one end of the caddy 700 and secured by clip 712 on the other end of the caddy 700. Also, another paddle on the other side of the caddy is secured by a clip (not shown) on one end of the caddy 700 and secured by another clip (not shown) on the other end of the caddy 700. Further, a bungee cord could attach to clip 711, stretch over the board, and attach to the corresponding clip on the back side of the cradle 702. Further, a bungee cord could attach to clip 712, stretch over the board, and attach to the corresponding clip on the back side of the cradle 703.

FIG. 8 shows the caddy 700 carrying a canoe 800. The canoe 800 is received and retained by the cradles 702 and 703. The cradles 702 and 703 ensure that the canoe does not fall off the caddy 700.

1. A caddy, comprising:
a frame comprising four wheels, each wheel coupled to a corner of the frame;
a first cradle coupled to a first end of the frame;
a second cradle coupled to a second [[side]]end of the frame wherein the first cradle receives a first end of a water apparatus and the second cradle receives a second end of the water apparatus for transporting the water apparatus.

2. The caddy of claim 1, wherein the first cradle comprises a first U-shaped bar, and the second cradle comprises a second U-shaped bar, the first and second U-shaped bars configured to receive the water apparatus for transport.

3. The caddy of claim 2, wherein the first U-shaped bar is integral with an inverted U-shaped bar on a first side of the first U-shaped bar and an inverted U-shaped bar on a second side of the first U-shaped bar.

4. The caddy of claim 3, wherein the second U-shaped bar is integral with an inverted U-shaped bar on a first side of the second U-shaped bar and an inverted U-shaped bar on a second side of the second U-shaped bar.

5. The caddy of claim 1, wherein the first cradle comprises a first clip on one side of the first cradle and a second clip on another side of the first cradle, the first and second clips configured such that a bungee cord is attached to the first clip, stretched across the water apparatus and attached to the second clip to retain the water apparatus on the caddy.

6. The caddy of claim 1, wherein the second cradle comprises a first clip on one side of the second cradle and a second clip on another side of the second cradle, the first and second clips configured such that a bungee cord is attached to the first clip, stretched across the water apparatus and attached to the second clip to retain the water apparatus on the caddy.

7. The caddy of claim 1, wherein the first cradle is rotatably coupled to the frame such that the first cradle may be rotated to a position directly adjacent the frame.

8. The caddy of claim 7, wherein the first cradle is rotatably coupled to the frame via a first cross bar.

9. The caddy of claim 7, wherein the second cradle is rotatably coupled to the frame such that the second cradle may be rotated to a position directly adjacent the frame.

10. The caddy of claim 9, wherein the second cradle is rotatably coupled to the frame via a second cross bar.

11. The caddy of claim 1, wherein the frame comprises a first portion and a second portion.

12. The caddy of claim 11, wherein the first portion is hingedly coupled to the second portion via a first joint and a second joint.

13. The caddy of claim 12, wherein the first portion is rotatable at the first joint and the second joint such that the first portion may be moved to an underside of the frame for storage.

14. The caddy of claim 1, wherein the first cradle comprises first two vertical bars connected to a first horizontal bar wherein the first horizontal bar is substantially perpendicular to the first two vertical bars.

15. The caddy of claim 14, wherein the second cradle comprises second two vertical bars connected to a second horizontal bar wherein the second horizontal bar is substantially perpendicular to the second two vertical bars.

16. The caddy of claim 15, wherein the first and second two vertical bars and the first and second horizontal bars are configured for receiving and retaining the water apparatus.

17. The caddy of claim 1, wherein the first cradle comprises a first top horizontal bar and a first bottom horizontal bar connected to first two vertical bars and forming a first rectangle.

18. The caddy of claim 17, wherein the first two vertical bars extend beyond the first top horizontal bar forming a first shelf for receiving a first end of the water apparatus for transport.

19. The caddy of claim 18, wherein the second cradle comprises a second top horizontal bar and a second bottom horizontal bar connected to second two vertical bars and forming a second rectangle.

20. The caddy of claim 19, wherein the second two vertical bars extend beyond the second top horizontal bar forming a second shelf for receiving a second end of the water apparatus for transport.

21. The caddy of claim 1, wherein the first cradle comprises a first clip on one side of the first cradle and a second clip on another side of the first cradle and the second cradle comprises a first clip on one side of the second cradle and a second clip on another side of the second cradle such that a first paddle may be retained by the first clips and a second paddle may be retained by the second clips.

22. The caddy of claim 1, wherein the frame is substantially rectangular.
